(19) United States
(12) Patent Application Publication
(10) Pub. No.: US 2004/0098149 A1
(43) Pub. Date: May 20, 2004

(54) Digital audio sampling scheme

(76) Inventors: Chuan Liu, Tainan (TW); Chih-Hsien Tsou, Taipei (TW); Yu-Chih Chin, Kaohsiung (TW)

Correspondence Address: BIRCH STEWART KOLASCH & BIRCH, PO BOX 747, FALLS CHURCH, VA, 22040-0747, US

(21) Appl. No.: 10/294,740

(22) Filed: Nov. 15, 2002

(51) Int. Cl. G06F 17/00

(52) U.S. Cl. 700/94

(57) ABSTRACT

A digital audio sampling scheme, which includes a computer implementing a software program for computation of impulse responses for an SRC filter by the weighted least square algorithm. The weighted least square algorithm can alternately be carried into execution by a DSP or a specific IC. As such, the entire invention can efficiently minimize the computational power in software implementation.

### BACKGROUND OF THE INVENTION

1. Field of the Invention

This invention relates to a digital audio sampling scheme, which uses the weighted least square algorithm to explore the desired coefficients for implementation impulse responses of a SRC.

2. Description of the Related Art

In audio applications, as shown in FIG. 1, a digital mixer 15 can now mix many audio waves from, such as an audio card 11, a sounder 12, a CD player 13, and a cassette player 14, of different sampling rates, and thus get more rich enjoyment of digital audio through a back-end circuit 16 and a left and right speakers 17, 18. Converting the digital audio data to the required sampling rate is the key to audio mixer. FIG. 2 is a plot of a wave function resulting from a sampling rate of 32 Hz. FIG. 3 is a plot of a frequency response of FIG. 1 by the Discrete Fourier Transform (DFT). FIG. 4 is a plot of a frequency response of FIG. 1 with the sampling rate of 512 Hz. FIG. 5 is a block diagram of a typical sample rate converter (SRC) to perform the sampling change (for example, from 32 Hz of FIG. 2 to 512 Hz of FIG. 3). In FIG. 5, in practice, the sampling rate conversion is performed in time domain for simplifying the computation. As shown in FIG. 5, the input data xₖ at time T passes through an interpolation means 41 for inserting zeros between each pair of samples, a low pass filter 42 for performing the DFT (convolution operation) and a scaler 43 for producing the required time scale for the convolution operation, and produces an output yₖ. For implementation of such an SRC in a digital mixer system, the typical approach uses a Finite Impulse Response low pass filter (hereinafter, referred to as an FIR filter). The oversampling process, which uses the interpolation computation to obtain the signal amplitude information between the sampling points, is of main interest in the FIR filter design, especially in producing the impulse response for the oversampling process. Conventionally, Remez exchange algorithm is applied to it. However, in design of FIR filters that are optimum in the minimax sense, this algorithm is sophisticated and not easy to be implemented in software computation.

### SUMMARY OF THE INVENTION

Therefore, an object of the invention is to provide a digital audio sampling scheme, which uses the weighted least square algorithm to explore the desired coefficients for implementation of impulse responses of an SRC.

Accordingly, the digital audio sampling scheme includes a computer implementing a software program for computation of impulse responses for an SRC filter by the weighted least square algorithm. As such, the invention can efficiently minimize the computational power in software implementation.

### BRIEF DESCRIPTION OF THE DRAWINGS

FIG. 1 shows a block diagram of a typical digital audio system;

FIG. 2 is a plot of a wave function resulting from a sampling rate of 32 Hz;

FIG. 3 is a plot of a frequency response of FIG. 1 by the Discrete Fourier Transform;

FIG. 4 is a plot of a frequency response of FIG. 1 with the sampling rate of 512 Hz;

FIG. 5 is a block diagram of a typical sample rate converter (SRC) for changing the sampling rate;

FIG. 6 shows a block diagram of a digital audio mixer according to the invention; and

FIG. 7 shows a plot of a comparison between the frequency response of a filter optimum in the Remez exchange sense and that in the weighted least squares sense.

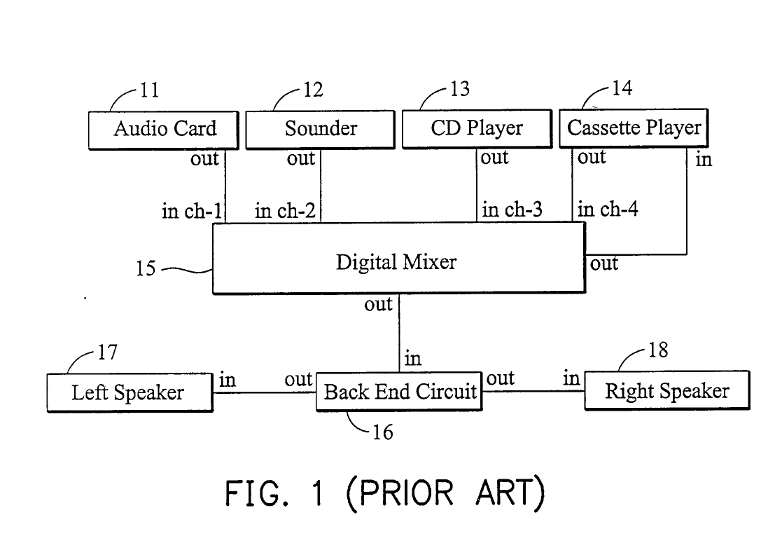

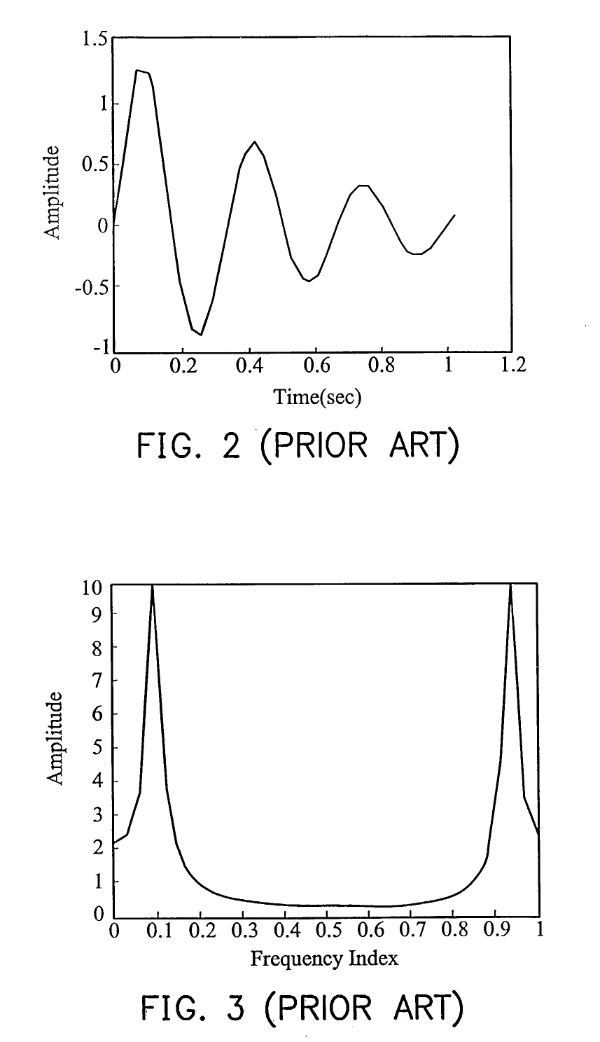

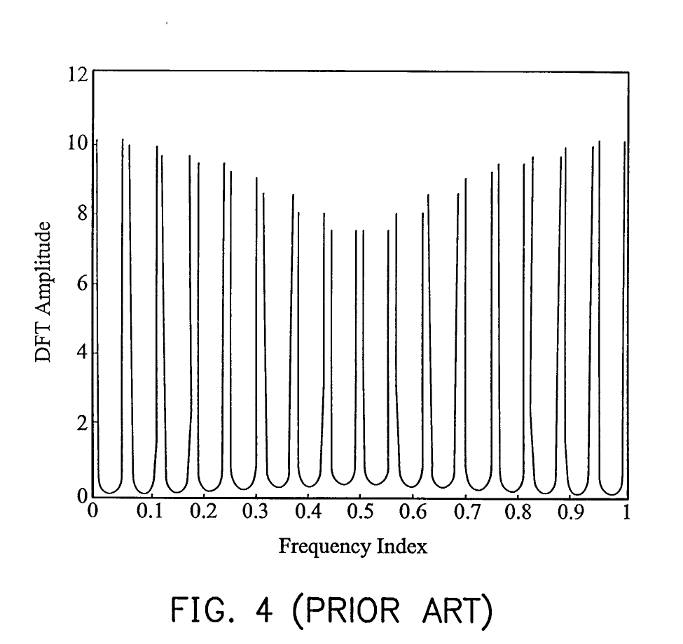

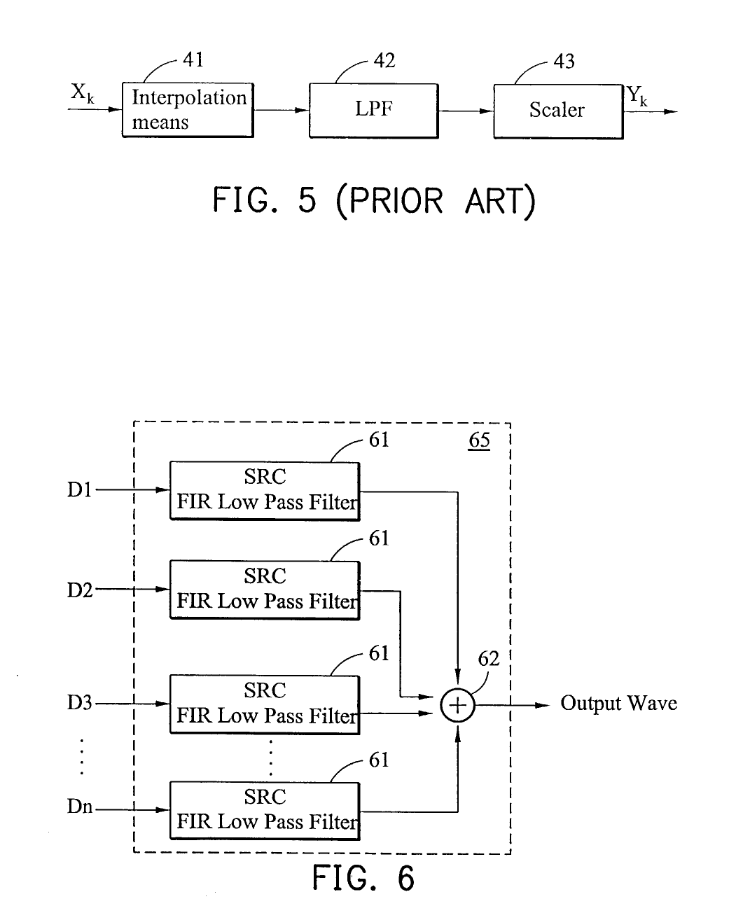

### DETAILED DESCRIPTION OF THE INVENTION

The following similar function elements are denoted by the same reference numerals.

FIG. 6 shows a block diagram of a digital audio mixer according to the invention shows. In FIG. 6, all input digital audio data Dl-Dn is mixed by an adder 62 via the relative sample rate converter (SRC) FIR filter 61 to produce an output wave. As shown in FIG. 6, the filters 61 and the adder 62 form a mixer 65. Implementation of the mixer 65 is the same as that in the prior art except for the filter implementation method using the weighted least square algorithm. The frequency response of the filter with weighted least square algorithm can be expressed as

$$P ( z ) = {\sum }_{n = 0}^{N} {p}_{n} {z}^{- n} \qquad ( 1 )$$

where P(z) is the z-transform transfer function. The coefficient pₙ is related to the impulse response of the filter, whereas N is a function of the filter length (order).

Let Ĥ (z) be the desired frequency response of the filter and the frequency response error function E is then given by

$$E ( z ) = {\sum }_{n = 0}^{N} {p}_{n} {z}^{- n} - \hat{H} ( z ) \qquad ( 2 )$$

Equation (2) can be evaluated on a dense grid of frequencies linearly distributed from ω=0 to π to form a set of linear equations. For a filter with length N, 4 N frequency grid points are adequate. If the band edges are not on the frequency grid points, then additional grid points corresponding to the band edges are added. The following vector equation may be written:

E=Ua−Ĥ (3)

where

E=[E(z₁), E(z₂), . . . ]^{T} (4)

$$U = [ \begin{matrix}1 , & {z}_{1}^{- 1} , & {z}_{1}^{- 2} & , … , & {z}_{1}^{- N} \\ 1 , & {z}_{2}^{- 1} , & {z}_{2}^{- 2} & , … , & {z}_{2}^{- N} \\ ⋮ & ⋮ & ⋮ & ⋮ & ⋮\end{matrix} ] \qquad ( 5 )$$

a=[p₀, . . . , p_{N}]^{T} (6)

Ĥ=[Ĥ (z₁), Ĥ (z₂), . . . ]^{T} (7)

where zᵢ₊₁>zᵢ.

In the weighted least squares design, Σₙ {rₙE(zₙ)²} is minimized where rₙ is the least square weighting value. The optimum solution is given by the following equation.

a=(U^{T}RU)⁻¹U^{T}RĤ (8)

where R can be a diagonal matrix whose nth diagonal element is rₙ:

$$R = [ \begin{matrix}{r}_{1} & & 0 \\ & {r}_{2} & \\ 0 & & ⋰\end{matrix} ] \qquad ( 9 )$$

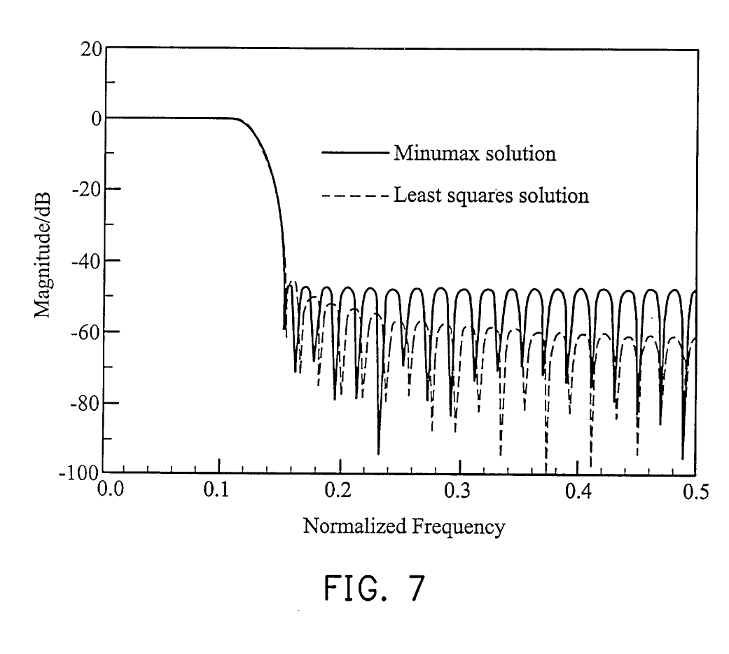

An example of linear phase low pass filters with an exponential function as the linear phase term in equations 1-9 is illustrated in comparison with the prior art, as shown in FIG. 7. The comparison is under the conditions of band edges at 0.15 of the sampling frequency, filter length at 51 and rₙ=1 for all n. It can be seen from FIG. 7 that least square design has a much smaller ripple magnitude than the prior art. Further, the performance of the least square design near the band edge can be improved at the expense of its performance elsewhere by using a relatively larger rₙ near the band edges. This is the essence of the weighted least square technique.

Accordingly, the digital audio sampling scheme includes a computer implementing a software program for computation of impulse responses for an SRC filter by the weighted least square algorithm. The weighted least square algorithm can also be carried into execution by a DSP or a specific IC, not limited by the computer. As such, the entire invention can minimize the computational power in software implementation.

Although the invention has been described in its preferred embodiment, it is not intended to limit the invention to the precise embodiment disclosed herein. Those who are skilled in this technology can still make various alterations and modifications without departing from the scope and spirit of this invention. Therefore, the scope of the invention shall be defined and protected by the following claims and their equivalents.

What is claimed is:

1. A digital audio sampling scheme comprising a computer implementing a software program for computation of impulse responses for a sampling rate conversion (SRC) filter by the weighted least square algorithm, so that the SRC filter uses the impulse responses whose corresponding spectra have notches at multiples of a sampling frequency, to further produce the desired frequency response.

2. The digital audio sampling scheme of claim 1, wherein the weighted least square algorithm implementation is a DSP.

3. The digital audio sampling scheme of claim 1, wherein the weighted least square algorithm implementation is a specific IC.

4. The digital audio sampling scheme of.claim 1, wherein the impulse responses are expressed by a=(U^{T}RU)⁻¹U^{T}RĤ, where Ĥ is the desired frequency response, U is the filtering function, R is a diagonal matrix whose nth diagonal element is the desired least square weighting value, and T is the reverse operation.

5. The digital audio sampling scheme of claim 5, wherein the Ĥ, R and U are expressed by the following equations:
Ĥ=[Ĥ (z₁), Ĥ (z₂), . . . ]^{T}
$$R = [ \begin{matrix}{r}_{1} & & 0 \\ & {r}_{2} & \\ 0 & & ⋰\end{matrix} ] U = [ \begin{matrix}1 , & {z}_{- 1} & , … , & {z}_{- 1 N} \\ 1 , & {z}_{- 2} & , … , & {z}_{- 2 N} \\ ⋮ & ⋮ & ⋮ & ⋮\end{matrix} ]$$
where r₁, r₂ . . . are the least square weighting function; z is Fourier transform transfer function that converts the externally input audio signal in time domain into the desired frequency response in frequency domain and zᵢ₊₁>zᵢ for i=1 to N, wherein N is the length of the FIR low pass filter.

6. A mixer with a digital audio sampling scheme, the digital audio sampling scheme comprising a means for computation of impulse responses by the weighted least square algorithm, the mixer comprising:
a plurality of parallel SRC filters each having one or more impulse responses and each connected to an externally different audio source, to receive samples from the externally different audio sources and convolute the one or more impulse response with samples to produce desired output coefficients that forms the desired frequency response; and
an adder, connected to the plurality of parallel SRC filters, to combine the output coefficients to be an audio output.

7. The mixer of claim 6, wherein the means is a DSP with the weighted least square algorithm implementation.

8. The mixer of claim 6, wherein the means is a specific IC with the weighted least square algorithm implementation.

9. The mixer of claim 7, wherein the means is a computer with the weighted least square algorithm implementation.

10. The mixer of claim 7, wherein the samples are expressed by a=(U^{T}RU)⁻¹U^{T}RĤ,
where Ĥ is the desired frequency response, U is the filtering function, R is a diagonal matrix whose nth diagonal element is the desired least square weighting value, and T is the reverse operation.

11. The mixer of claim 11, wherein the Ĥ, R and U are expressed by the following equations:
Ĥ=[Ĥ (z₁), Ĥ (z₂), . . . ]^{T}
$$R = [ \begin{matrix}{r}_{1} & & 0 \\ & {r}_{2} & \\ 0 & & ⋰\end{matrix} ] U = [ \begin{matrix}1 , & {z}_{1}^{- 1} , & {z}_{1}^{- 2} & , … , & {z}_{1}^{- N} \\ 1 , & {z}_{2}^{- 1} , & {z}_{2}^{- 2} & , … , & {z}_{2}^{- N} \\ ⋮ & ⋮ & ⋮ & ⋮ & ⋮\end{matrix} ]$$
where r₁, r₂ . . . are the least square weighting function; z is Fourier transform transfer function that converts the different audio signals in time domain into the desired frequency responses in frequency domain and zᵢ₊₁>zᵢ for i=1to N wherein N is the length of the FIR low pass filter.
